(19) United States
(12) Patent Application Publication
(10) Pub. No.: US 2026/0132959 A1
(43) Pub. Date: May 14, 2026

(54) WATER HEATER

(71) Applicant: WUHU MIDEA KITCHEN AND BATH APPLIANCES MFG. CO., LTD., Wuhu (CN)

(72) Inventors: Xinyu WANG, Wuhu (CN); Yongbing SHEN, Wuhu (CN)

(21) Appl. No.: 19/360,049

(22) Filed: Oct. 16, 2025

(30) Foreign Application Priority Data
Nov. 13, 2024 (CN) 202422772361.X

(51) Int. Cl. F24H 9/00; F16L 59/16

(52) U.S. Cl. CPC F24H 9/0005; F16L 59/16

(57) ABSTRACT

A water heater includes a water tank provided with a water tank connector in which a water inlet channel is formed, a water inlet connector partially received in the water inlet channel and coupled with the water tank connector, a water inlet pipe partially arranged in the water inlet channel, a first insulation member arranged between the water inlet pipe and the water inlet connector to insulate the water inlet pipe from the water inlet connector, and a second insulation member arranged between the water inlet pipe and the water tank connector to insulate the water inlet pipe from the water tank connector.

### CROSS-REFERENCE TO RELATED APPLICATION

This application claims priority to Chinese Patent Application No. 202422772361.X, filed on November 13, 2024, which is hereby incorporated by reference in its entirety.

### FIELD

The present disclosure relates to water heaters, and more particularly, to a water heater.

### BACKGROUND

In the related art, a water inlet pipe of a water heater is usually made of plastic. The use of plastic material can prevent excessive consumption of the magnesium rod. However, there are problems: plastic is prone to aging, and when an inner tank is dry burned, the water inlet pipe may be deformed or damaged. Making the water inlet pipe using stainless steel can effectively avoid the above problems. In addition, the stainless steel has strong corrosion resistance and does not require protection of the magnesium rod. However, in existing designs, the water inlet pipe is connected to the inner tank, allowing the magnesium rod to be communicated with the water inlet pipe and form an electrochemical pathway with the water inlet pipe, causing the magnesium rod to protect the water inlet pipe, which affects a service life of the magnesium rod.

### SUMMARY

The present disclosure aims to solve at least one of the technical problems in the related art. To this end, an embodiment of the present disclosure is to provide a water heater that can avoid excessive consumption of a magnesium rod and prolong a service life of the magnesium rod.

The water heater according to the embodiment of the present disclosure includes: a water tank provided with a water tank connector, a water inlet channel being formed in the water tank connector; a water inlet connector partially received in the water inlet channel and coupled with the water tank connector; and a water inlet pipe partially arranged in the water inlet channel. A first insulation member is arranged between the water inlet pipe and the water inlet connector to insulate the water inlet pipe from the water inlet connector. A second insulation member is arranged between the water inlet pipe and the water tank connector to insulate the water inlet pipe from the water tank connector.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become apparent and readily understood from the following description of embodiments in conjunction with the accompanying drawings, in which:

FIG. 1 is a schematic structural view of a heat insulation assembly according to an embodiment of the present disclosure.

FIG. 2 is a schematic cross-sectional view of the heat insulation assembly shown in FIG. 1.

FIG. 3 is a schematic exploded view of the heat insulation assembly shown in FIG. 1.

FIG. 4 is a schematic structural view of a heat insulation pipe in FIG. 1.

FIG. 5 is a schematic front view of the heat insulation pipe shown in FIG. 4.

FIG. 6 is a schematic cross-sectional view of the heat insulation pipe shown in FIG. 5.

FIG. 7 is a schematic structural view of a heat insulation assembly according to another embodiment of the present disclosure.

FIG. 8 is a schematic exploded view of the heat insulation assembly shown in FIG. 7.

FIG. 9 is a schematic cross-sectional view of the heat insulation assembly shown in FIG. 7.

FIG. 10 is a schematic structural view of a heat insulation pipe in FIG. 7.

FIG. 11 is a schematic front view of the heat insulation pipe shown in FIG. 10.

FIG. 12 is a schematic cross-sectional view of the heat insulation pipe shown in FIG. 11.

FIG. 13 is a schematic cross-sectional view of a heat insulation assembly according to another embodiment of the present disclosure.

FIG. 14 is a schematic structural view of a coupling device according to an embodiment of the present disclosure.

FIG. 15 is a schematic cross-sectional view of the coupling device shown in FIG. 14.

FIG. 16 is a schematic cross-sectional view of a coupling device according to another embodiment of the present disclosure.

FIG. 17 is a schematic cross-sectional view of a first engagement member and a second engagement member according to an embodiment of the present disclosure.

FIG. 18 is a schematic cross-sectional view of the coupling device in FIG. 14 when water flows through the coupling device.

FIG. 19 is a schematic cross-sectional view of a water heater according to an embodiment of the present disclosure.

FIG. 20 is a schematic partially enlarged view of a portion indicated by circle A in FIG. 19.

Reference numerals:

10, heat insulation assembly;

11, heat insulation pipe; 111, first channel;

112, mounting groove; 1121, mounting aperture; 1122, second protrusion; 1123, first side wall; 1124, second side wall; 1125, first limit member; 1126, third protrusion;

113, engagement claw; 1131, connection arm; 1132, engagement head; 114, deformation hole; 115, protrusion;

116, first segment; 117, second segment; 118, limit member; 119, flow channel;

12, heat insulation member; 121, heat insulation sheet; 1211, first protrusion; 1212. guide surface; 122, second limit member;

123, connection member; 13, first engagement member; 14, second engagement member;

20, coupling device; 21, water pipe connector; 211, mounting channel; 212, balance cavity;

30, water heater; 31, water tank;

311, water tank connector; 3111, water inlet channel; 3112, first connector segment; 3113, second connector segment;

312, step surface; 313, water tank cavity; 314, heat preservation member;

315, decoration member; 32, first insulation member;

33, second insulation member; 331, first insulation part; 3311, third limit member;

332, second insulation part; 333, extension; 34, water inlet pipe; 341, first flange.

### DETAILED DESCRIPTION

Embodiments of the present disclosure are described in detail below with reference to examples thereof as illustrated in the accompanying drawings, throughout which same or similar elements, or elements having same or similar functions, are denoted by same or similar reference numerals. The embodiments described below with reference to the accompanying drawings are illustrative only, and are intended to explain, rather than limiting, the present disclosure.

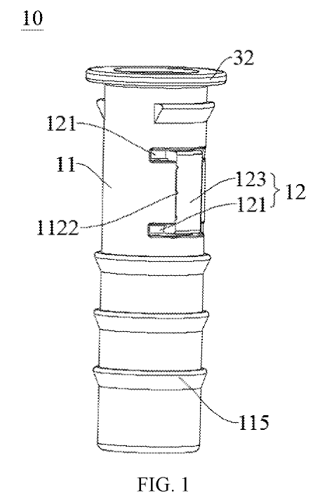

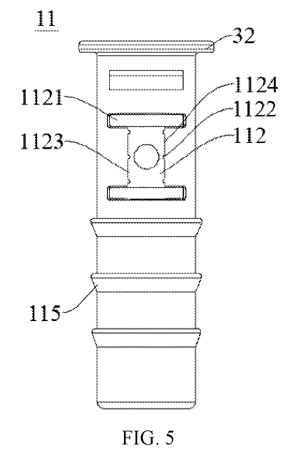

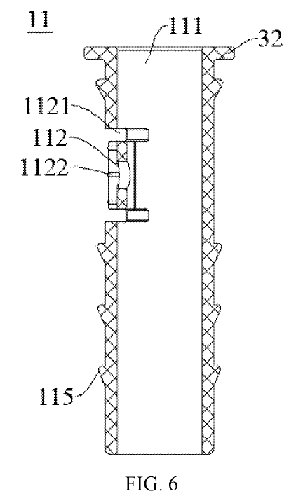

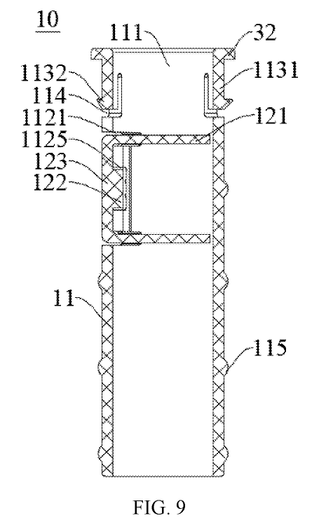

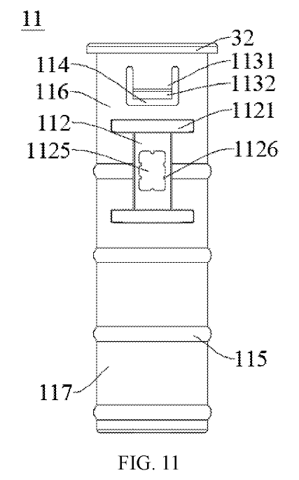

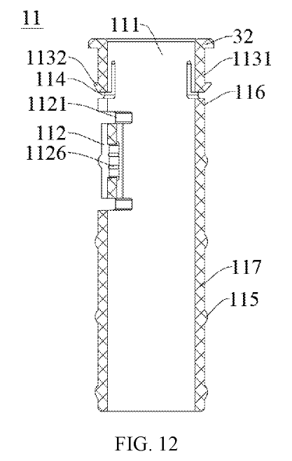

A heat insulation assembly 10 for a coupling device 20 according to the embodiments of the present disclosure is described below with reference to FIG. 1 to FIG. 13. The heat insulation assembly 10 includes a heat insulation pipe 11 and a heat insulation member 12. The heat insulation pipe 11 has a first channel 111 extending through the heat insulation pipe 11 in an axial direction of the heat insulation pipe 11. The heat insulation member 12 includes a plurality of heat insulation sheets 121, and at least part of the heat insulation sheet 121 is radially arranged in the first channel 111. A limit member 118 is formed at the heat insulation member 12 and/or the heat insulation pipe 11, and is adapted to restrict a radial movement of the heat insulation member 12 relative to the heat insulation pipe 11.

As shown in FIG. 1 to FIG. 3, in an exemplary embodiment of the present disclosure, the heat insulation assembly 10 may include the heat insulation pipe 11 and the heat insulation member 12. The first channel 111 may be formed in the heat insulation pipe 11, and may extend axially through the heat insulation pipe 11. The first channel 111 may be used for liquid flow. In some embodiments, the heat insulation pipe 11 may be arranged at a connector of a water inlet end or a connector of a water outlet end of the water heater 30. The heat insulation pipe 11 may reduce heat exchange of heat inside a water tank 31 with an external environment through the water pipe connector 21 when the water heater 30 is in static heat preservation.

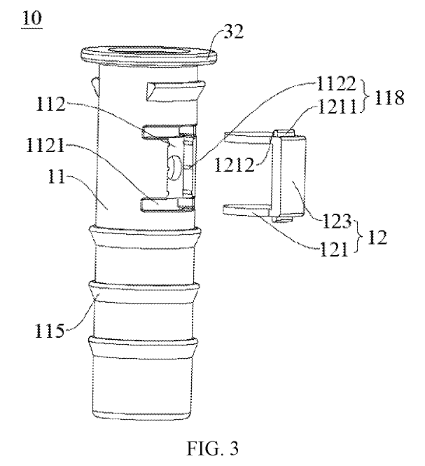

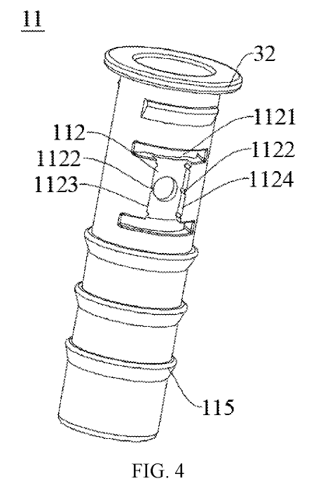

As shown in FIG. 3 and FIG. 4, the heat insulation member 12 includes a heat insulation sheet 121. A plurality of heat insulation sheets 121 may be provided, and may be axially arranged at intervals or may be arranged at intervals in an extending direction of the heat insulation member 12. The axial direction may refer to the axial direction of the heat insulation pipe 11. In some embodiments, the extending direction of the heat insulation member 12 may be the same as the axial direction of the heat insulation pipe 11.

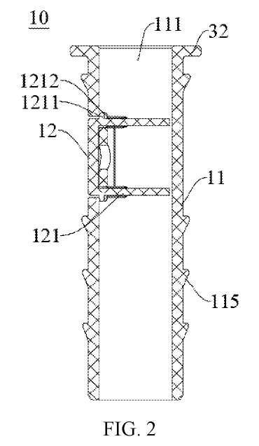

As shown in FIG. 2 and FIG. 3, at least part of the heat insulation sheet 121 may be radially arranged in the first channel 111. It should be noted that the heat insulation sheet 121 is made of a soft material. When water flows through the first channel 111, the heat insulation sheet 121 may be bent to achieve circulation of water flow. When the water heater 30 is in static heat preservation, the heat insulation sheet 121 may reduce heat exchanged between the interior of the water tank 31 and low-temperature water in the first channel 111. In this way, heat loss of the water heater 30 is reduced during the heat preservation.

Further, the limit member 118 may be formed at the heat insulation member 12 or the heat insulation pipe 11, and may restrict a movement of the heat insulation member 12 relative to the heat insulation pipe 11. For example, the limit member 118 may be formed at the heat insulation member 12, and is capable of cooperating with the heat insulation pipe 11 to restrict a relative radial movement between the heat insulation member 12 and the heat insulation pipe 11. Alternatively, the limit member 118 may be formed at the heat insulation pipe 11, and is capable of cooperating with the heat insulation member 12 to restrict the relative radial movement between the heat insulation pipe 11 and the heat insulation member 12. In some embodiments, the limit member 118 may be formed at both the heat insulation member 12 and the heat insulation pipe 11, and the relative radial movement between the heat insulation member 12 and the heat insulation pipe 11 is restricted by the limit member 118, which ensure an engagement strength and an engagement effect between the heat insulation member 12 and the heat insulation pipe 11, enables the heat insulation member 12 to effectively achieve a heat insulation effect, and improves a service life of the heat insulation assembly 10.

In short, the heat insulation assembly 10 according to the embodiments of the present disclosure includes the heat insulation pipe 11 and the heat insulation member 12. The heat insulation member 12 may be provided with a heat insulation sheet 121 extending into the heat insulation pipe 11. The limit member 118 may be formed at the heat insulation member 12 and/or the heat insulation pipe 11, and may be configured to restrict a relative movement between the heat insulation member 12 and the heat insulation pipe 11, which improves the engagement strength between the heat insulation member 12 and the heat insulation pipe 11, ensures heat insulation efficiency of the heat insulation member 12, and further improves the service life and reliability of the heat insulation assembly 10.

In some embodiments of the present disclosure, the limit member 118 may abut against an inner wall of the first channel 111 to achieve limiting between the heat insulation sheet 121 or the heat insulation member 12 and the heat insulation pipe 11. In an exemplary embodiment of the present disclosure, the limit member 118 abuts against the inner wall of the first channel 111 radially, and the radial direction refers to a radial direction of the heat insulation pipe 11. The limit member 118 may extend in the axial direction, and a side of the limit member 118 may abut against the inner wall of the first channel 111 radially, to achieve the limiting between the heat insulation sheet 121 or the heat insulation member 12 and the heat insulation pipe 11, and further restrict decoupling of the heat insulation member 12 from the heat insulation pipe 11.

Further, as shown in FIG. 2 and FIG. 3, the limit member 118 may include a first protrusion 1211 arranged on at least one side of each of at least one heat insulation sheet 121 of the plurality of heat insulation sheets 121 facing towards or away from an adjacent heat insulation sheet 121 of the at least one of the plurality of heat insulation sheets 121. The first protrusion 1211 abuts against the inner wall of the first channel 111. It should be noted that at least one heat insulation sheet 121 may be provided with the first protrusion 1211, and the first protrusion 1211 may be arranged on a side of one heat insulation sheet 121 facing towards another heat insulation sheet 121 and/or a side of the one heat insulation sheet 121 away from the other heat insulation sheet 121. The first protrusion 1211 may extend in the axial direction, and a side of the first protrusion 1211 in a radial direction of the first protrusion 1211 may abut against the inner wall of the first channel 111, to restrict decoupling of the heat insulation member 12 from the heat insulation pipe 11.

As shown in FIG. 2 and FIG. 3, in some embodiments of the present disclosure, a side of the first protrusion 1211 towards the inner wall of the first channel 111 may abut against the inner wall of the first channel 111 to restrict the movement of the heat insulation member 12. The first protrusion 1211 may have a guide surface 1212 formed at a side of the first protrusion 1211 away from the inner wall of the first channel 111. The guide surface 1212 may achieve an effect of facilitating mounting. During actual assembly, the heat insulation member 12 is pressed to cooperate with the heat insulation pipe 11. Since the first protrusion 1211 has an interference problem, by forming the guide surface 1212, it is beneficial to press the first protrusion 1211 into the first channel 111, improving assembly efficiency, while reducing wear of the first protrusion 1211. In a specific embodiment, the guide surface 1212 may be constructed into an arc shape surface, which further reduces friction during the assembly and is beneficial to assembly of the heat insulation member 12.

In some embodiments of the present disclosure, a maximum dimension of a radially overlapping part between the first protrusion 1211 and the heat insulation pipe 11 in an extending direction of the heat insulation pipe 11 is S, where 0.2 mm≤S≤1 mm. That is, the radially overlapping part between the first protrusion 1211 and the heat insulation pipe 11 may be a part where the first protrusion 1211 actually achieves a limiting effect, and the maximum dimension of this part in the extending direction of the heat insulation pipe 11 may be an interference amount of the first protrusion 1211 relative to the heat insulation pipe 11. It can be understood that the maximum dimension of the radially overlapping part between the first protrusion 1211 and the heat insulation pipe 11 in the extending direction of the heat insulation pipe 11 is any value ranging from 0.2mm to 1mm. For example, the maximum dimension of the radially overlapping part between the first protrusion 1211 and the heat insulation pipe 11 in the extending direction of the heat insulation pipe 11 may be, but is not limited to, 0.2mm, 0.4mm, 0.6mm, 0.8mm, 1mm, or the like. In response to the maximum dimension S being too large, mounting difficulty of the heat insulation member 12 is increased. In response to the maximum dimension S being too small, the limiting between the heat insulation member 12 and the heat insulation pipe 11 fails to satisfy the requirements. Therefore, by setting the maximum dimension S within the above range, the engagement strength between the heat insulation member 12 and the heat insulation pipe 11 can be ensured.

As shown in FIG. 1 and FIG. 3, the heat insulation member 12 may further include a connection member 123. The connection member 123 may be arranged at the heat insulation pipe 11 and may extend in the axial direction of the heat insulation pipe 11. The plurality of heat insulation sheets 121 may be formed at an inner side surface of the connection member 123 towards the first channel 111. The plurality of heat insulation sheets 121 may extend radially and may be arranged at intervals in an extending direction of the connection member 123. In another exemplary embodiment of the present disclosure, the heat insulation sheet 121 and the connection member 123 may be constructed to be integrally formed or be fixed by bonding or in other connection manners.

As shown in FIG. 4, in some embodiments of the present disclosure, the heat insulation pipe 11 further has a mounting groove 1120 formed at an outer circumferential wall of the heat insulation pipe 11, and the mounting groove 1120 may be recessed towards the first channel 111. By forming the mounting groove 1120, the space occupied by the heat insulation pipe 11 can be reduced, which is beneficial to mounting of the heat insulation pipe 11 in the water pipe connector 21. The connection member 123 may cooperate with the mounting groove 1120 to mount the heat insulation member 12 on the heat insulation pipe 11. In another exemplary embodiment of the present disclosure, the connection member 123 and the mounting groove 1120 may be detachably connected through snapping or insertion. Further, the mounting groove 1120 may have a mounting aperture 1121 formed at a bottom wall of the mounting groove 1120, and the mounting aperture 1121 may extend radially through the mounting groove 1120. Moreover, the heat insulation sheet 121 may extend into the first channel 111 through the mounting aperture 1121. During actual mounting, the first protrusion 1211 may also extend into the first channel 111 through the mounting aperture 1121 and abut against the inner wall of the first channel 111. In some embodiments, a plurality of mounting apertures 1121 may be formed and may correspond to the plurality of heat insulation sheets 121 in one-to-one correspondence to facilitate the plurality of heat insulation sheets 121 each extending into the first channel 111.

As shown in FIG. 4 to FIG. 6, in some embodiments of the present disclosure, the limit member 118 may include a second protrusion 1122. Inner walls of the mounting groove 1120 at two sides of the mounting groove 1120 in a circumferential direction of the heat insulation pipe 11 may be respectively constructed as a first side wall 1123 and a second side wall 1124. At least one of the first side wall 1123 or the second side wall 1124 may be provided with the second protrusion 1122 formed thereon. The second protrusion 1122 may extend towards the connection member 123 and abut against the connection member 123. The second protrusion 1122 may realize circumferential limiting between the connection member 123 and the mounting groove 1120, improve the engagement strength between the heat insulation member 12 and the heat insulation pipe 11, and restrict a circumferential movement of the heat insulation member 12 relative to the heat insulation pipe 11. Moreover, the second protrusion 1122 may also increase friction between the connection member 123 and a side wall of the mounting groove 1120, avoiding decoupling of the heat insulation sheet 121 from the heat insulation pipe 11. easily

Further, a plurality of second protrusions 1122 may be provided and axially arranged at intervals. By providing the plurality of second protrusions 1122, the engagement strength between the heat insulation member 12 and the heat insulation pipe 11 can be further improved to achieve the effect of limiting the circumferential movement of the heat insulation member 12 relative to the heat insulation pipe 11. In some embodiments, 4 or more second protrusions 1122 may be constructed, to ensure the engagement strength between the heat insulation member 12 and the heat insulation pipe 11. A maximum dimension of the second protrusion 1122 in the circumferential direction is L, where 0.2mm≤L≤1mm. That is, the maximum dimension of the second protrusion 1122 in the circumferential direction is any value ranging from 0.2mm to 1mm. For example, the maximum dimension of the second protrusion 1122 in the circumferential direction may be, but is not limited to, 0.2mm, 0.4mm, 0.6mm, 0.8mm, 1mm, or the like. Such an arrangement can ensure that the second protrusion 1122 can improve a circumferential limiting effect between the connection member 123 and the mounting groove 1120 without affecting the assembly of the heat insulation member 12.

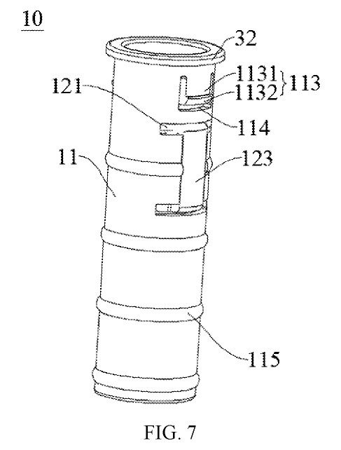

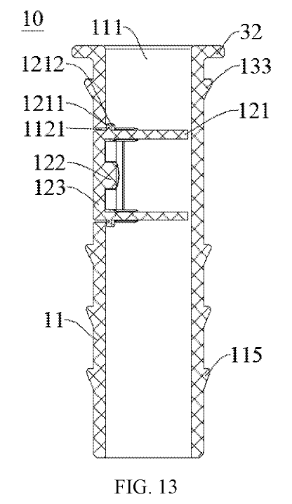

As shown in FIG. 7 to FIG. 9, in some embodiments of the present disclosure, a first limit member 1125 may be formed at the bottom wall of the mounting groove 1120, and the connection member 123 has a second limit member 122. The second limit member 122 may be arranged corresponding to the first limit member 1125, and may also cooperate with the first limit member 1125, to restrict a movement of the connection member 123 relative to the bottom wall of the mounting groove 1120, improving an engagement effect between the connection member 123 and the mounting groove 1120. Further, one of the first limit member 1125 and the second limit member 122 may be constructed as a limit hole, and another one of the first limit member 1125 and the second limit member 122 may be constructed as a limit protrusion. In a specific embodiment, the limit hole may be formed at the bottom wall of the mounting groove 1120, and the connection member 123 may have a limit protrusion formed at the connection member 123 and engaged with the limit hole. The limit hole may be constructed as a circular hole or a polygonal hole to facilitate processing and assembly of the limit hole. As shown in FIG. 13, in other embodiments, the limit hole may also be constructed as a hole in other irregular shapes. It should be noted that the limit hole may be applied to various scenarios. For example, when the processed heat insulation member 12 is transported to a factory for assembly with the water pipe connector 21, the limit hole and the limit protrusion are capable of avoiding decoupling of the heat insulation member 12 from the heat insulation pipe 11 during transportation. Alternatively, in an environment with high water pressure, the limit hole and the limit protrusion are capable of preventing the heat insulation member 12 from being washed away by water flow or deformed by water impact, making assembly of the heat insulation member 12 and the heat insulation pipe 11 firmer.

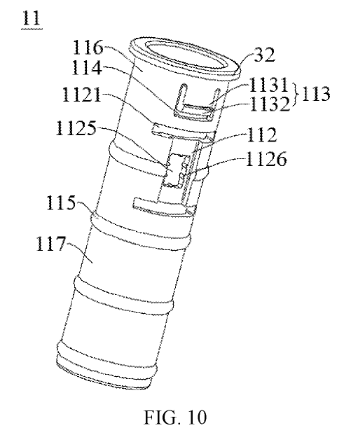

Further, as shown in FIG. 10 to FIG. 12, a third protrusion 1126 is arranged at the limit hole and extends towards the limit protrusion; and/ or a third protrusion 1126 is arranged at the limit protrusion and extends towards the limit hole. The third protrusion 1126 may realize an engagement between the limit hole and the limit protrusion in a limiting manner. In some embodiments, the third protrusion 1126 may be formed at an inner wall of the limit hole and extends towards the limit protrusion. Moreover, a free end of the third protrusion 1126 is capable of abutting against an outer circumferential wall of the limit protrusion. In this way, it is realized that the limit hole is engaged with the limit protrusion in a limiting manner. A plurality of third protrusions 1126 may be constructed, and may be arranged at intervals in the circumferential direction. By providing the plurality of third protrusions 1126, an engagement effect between the limit hole and the limit protrusion can be further improved, i.e., the engagement effect between the connection member 123 and the mounting groove 1120 is improved.

In some embodiments of the present disclosure, the heat insulation sheet 121 is constructed as a rubber member. In an exemplary embodiment of the present disclosure, the heat insulation sheet 121 may be made of ethylene propylene diene monomer (EPDM), nitrile butadiene rubber (NBR), fluororubber, and other materials. Hardness of the heat insulation sheet 121 may be designed to range from 40 to 70. Such an arrangement can ensure that the heat insulation sheet 121 may be deformed when there is water flow pressure, making the first channel 111 fully open to ensure the circulation of water flow. Moreover, this arrangement avoids a problem where partial deformation of the heat insulation sheet 121 causes incomplete opening of the first channel 111, obstructing the entire water path. A minimum deformation stress for ensuring complete deformation of the heat insulation sheet 121 needs to be smaller than water flow pressure in a normal use scenario, such as 0.01Mpa. When there is no water flow or pressure in the first channel 111, the heat insulation sheet 121 may return to its original state, to reduce heat loss inside the water tank 31. In addition, when the heat insulation member 12 is mounted, since the heat insulation sheet 1211 is made of a soft material by design at a position where the heat insulation sheet 121 has an interference fit with the heat insulation pipe 11, easier mounting of the heat insulation sheet 121 is enabled, which improves the assembly efficiency and reduces assembly difficulty.

The coupling device 20 is briefly described below according to the embodiments of the present disclosure.

The coupling device 20 according to the embodiments of the present disclosure is provided with a water pipe connector 21 and the heat insulation assembly 10 according to the above embodiments. The heat insulation assembly 10 may be arranged inside the water pipe connector 21. Since the coupling device 20 according to the embodiments of the present disclosure is provided with the water pipe connector 21 and the heat insulation assembly 10 according to the above embodiments, by providing the heat insulation pipe 11 and the heat insulation member 12 in the coupling device 20, the limit member 118 may be formed at the heat insulation member 12 and/or the heat insulation pipe 11, and may be configured to restrict a relative movement between the heat insulation member 12 and the heat insulation pipe 11. In this way, an engagement strength between the heat insulation member 12 and the heat insulation pipe 11 is improved, heat insulation efficiency of the heat insulation assembly 10 is ensured, and a service life and reliability of the coupling device 20 are further improved.

The water heater 30 according to the embodiments of the present disclosure is briefly described below.

The water heater 30 according to the embodiments of the present disclosure is provided with the coupling device 20 according to the above embodiments. Since the water heater 30 according to the embodiments of the present disclosure is provided with the coupling device 20 according to the above embodiments, by providing the heat insulation pipe 11 and the heat insulation member 12 in the coupling device 20 for the water heater 30, the limit member 118 may be formed at the heat insulation member 12 and/or the heat insulation pipe 11. In this way, an engagement strength between the heat insulation member 12 and the heat insulation pipe 11 is improved, heat insulation efficiency of the heat insulation assembly 10 is ensured, and a service life and reliability of the coupling device 20 are further improved.

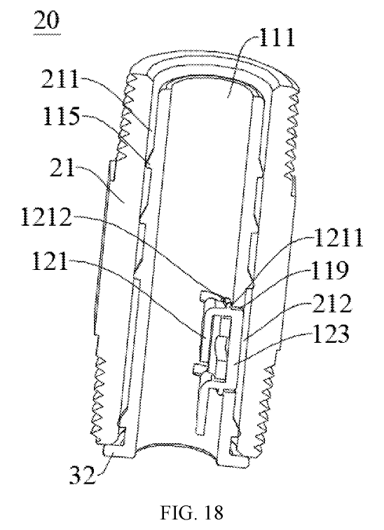

The coupling device 20 for the water heater 30 according to the embodiments of the present disclosure is described below with reference to FIG. 1 to FIG. 18. The coupling device 20 includes the water pipe connector 21, the heat insulation pipe 11, and the heat insulation member 12. The water pipe connector 21 has a mounting channel 211 formed in the water pipe connector 21 and extending in an axial direction of the water pipe connector 21. The heat insulation pipe 11 is arranged within the mounting channel 211, and at least part of the heat insulation pipe 11 is insulated from an inner circumferential wall of the water pipe connector 21 to form a balance cavity 212. The heat insulation pipe 11 has the first channel 111 extending axially through the heat insulation pipe 11. The heat insulation member 12 is arranged at the heat insulation pipe 11 and at least partially located in the balance cavity 212. The heat insulation member 12 includes the plurality of heat insulation sheets 121 that at least partially extends into the first channel 111. A flow channel 119 is formed at the heat insulation pipe 11, and the balance cavity 212 is in communication with the first channel 111 through the flow channel 119.

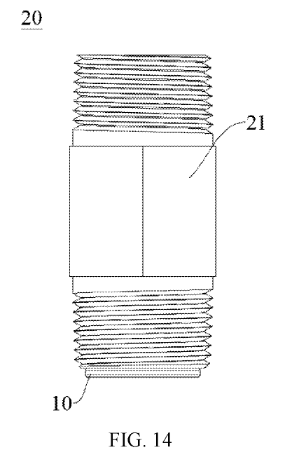

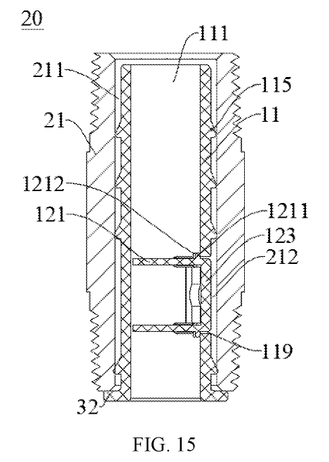

As shown in FIG. 14 and FIG. 15, in an exemplary embodiment of the present disclosure, the coupling device 20 may include the water pipe connector 21, the heat insulation pipe 11, and the heat insulation member 12. The mounting channel 211 may be formed in the water pipe connector 21 and may extend in the axial direction of the water pipe connector 21. The heat insulation pipe 11 may be arranged within the mounting channel 211. The heat insulation pipe 11 is capable of reducing heat exchange of heat inside a water tank 31 with an external environment through the water pipe connector 21 when the water heater 30 is in static heat preservation. The water pipe connector 21 may be a water inlet connector or a water outlet connector of the water heater.

As shown in FIG. 15, the at least part of the heat insulation pipe 11 may be insulated from the inner circumferential wall of the water pipe connector 21, and the balance cavity 212 is formed between the at least part of the heat insulation pipe 11 and the inner circumferential wall of the water pipe connector 21. The heat insulation pipe 11 may further have the first channel 111 formed at the heat insulation pipe 11, and the first channel 111 may extend through the heat insulation pipe 11 in the axial direction of the heat insulation pipe 11 and be used for flow of a low-temperature liquid. It should be noted that the axial direction of the water pipe connector 21 is the same as the axial direction of the heat insulation pipe 11.

The heat insulation member 12 may be arranged at the heat insulation pipe 11. In another exemplary embodiment of the present disclosure, the heat insulation member 12 and the heat insulation pipe 11 may be detachably connected through snapping or insertion. The plurality of heat insulation sheets 121 may be constructed, and the plurality of heat insulation sheets 121 may be arranged at intervals in an axial direction or in an extending direction of the heat insulation member 12. In some embodiments, the extending direction of the heat insulation member 12 may be the same as the axial direction of the heat insulation pipe 11.

Further, as shown in FIG. 15, the heat insulation member 12 may be at least partially located in the balance cavity 212, and a flow channel 119 may be formed at the heat insulation pipe 11. The balance cavity 212 may be in communication with the first channel 111 through the flow channel 119. It should be explained that when water is introduced into the first channel 111, a high intensity of pressure in the first channel 111 causes pressure to be exerted on the heat insulation member 12, making the heat insulation member 12 easily separated from the heat insulation pipe 11. To this end, by forming the flow channel 119, it can be ensured that when the water is introduced into the first channel 111, the water flow may partially flow into the balance cavity 212 through the flow channel 119, which makes the balance cavity 212 fully filled with water, and further makes water pressure in the balance cavity 212 balanced with water pressure in the first channel 111. Therefore, it is ensured that the heat insulation member 12 is not deformed or separated from the heat insulation pipe 11 due to the water pressure, and an engagement strength between the heat insulation member 12 and the heat insulation pipe 11 is improved.

In short, the coupling device 20 according to the embodiments of the present disclosure includes the water pipe connector 21, the heat insulation pipe 11, and the heat insulation member 12 arranged at the heat insulation pipe 11. The heat insulation pipe 11 may be arranged inside the water pipe connector 21 and be insulated from an inner wall of the water pipe connector 21 to form the balance cavity 212. The heat insulation pipe 11 may have the first channel 111 and the flow channel 119 that are formed in the heat insulation pipe 11, and the balance cavity 212 may be in communication with the first channel 111 through the flow channel 119. Therefore, after the water is introduced into the coupling device 20, the water pressure in the balance cavity 212 and the water pressure in the first channel 111 may be kept balanced, to avoid the deformation of the heat insulation member 12 or the decoupling of the heat insulation member 12 from the heat insulation pipe 11, which improves a connection strength between the heat insulation member 12 and the heat insulation pipe 11 and reliability of the coupling device 20.

In some embodiments of the present disclosure, the heat insulation member 12 may extend through the flow channel 119, and may extend into the first channel 111. It can be understood that the flow channel 119 may provide a predetermined space for mounting of the heat insulation member 12. Moreover, the flow channel 119 may still realize a function of circulation of water flow after the heat insulation member 12 is mounted in the flow channel 119. In this way, the number of openings formed at the heat insulation pipe 11 is reduced, and it is ensured that the flow channel 119 may be effective in communication with the balance cavity 212.

In some embodiments of the present disclosure, a shortest distance between an outer wall of the heat insulation member 12 and the inner circumferential wall of the water pipe connector 21 is D1, where 0.05 mm≤D1≤0.5 mm. It can be understood that the shortest distance between the outer wall of the heat insulation member 12 and the inner circumferential wall of the water pipe connector 21 may be any value ranging from 0.05 mm to 0.5 mm. For example, the shortest distance between the outer wall of the heat insulation member 12 and the inner circumferential wall of the water pipe connector 21 may be, but is not limited to, 0.05 mm, 0.1 mm, 0.3 mm, 0.5 mm, or the like. In response to a distance between the outer wall of the heat insulation member 12 and the inner circumferential wall of the water pipe connector 21 being too small, the heat insulation member 12 is caused to have interference with the inner circumferential wall of the water pipe connector 21 during the mounting of the heat insulation member 12, resulting in partial deformation or damage of the heat insulation member 12. In response to the distance between the outer wall of the heat insulation member 12 and the inner circumferential wall of the water pipe connector 21 being too large, it is difficult to achieve an effect of avoiding the decoupling of the heat insulation member 12. Therefore, by setting the shortest distance between the outer wall of the heat insulation member 12 and the inner circumferential wall of the water pipe connector 21 within the above range, when no interference is ensured to be caused during the mounting of the heat insulation member 12, the deformation of the heat insulation member 12 or the decoupling of the heat insulation member 12 from the heat insulation pipe 11 is further avoided, and the reliability of the coupling device 20 is improved.

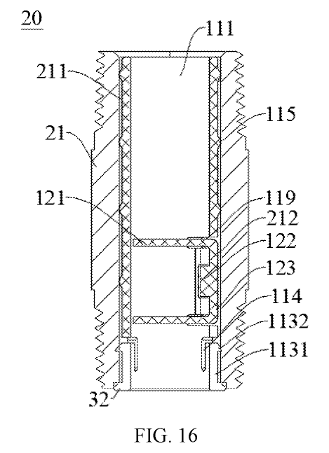

As shown in FIG. 15 and FIG. 16, in some embodiments of the present disclosure, a first engagement member 13 may be formed at an outer circumferential wall of the heat insulation pipe 11, and a second engagement member 14 may be formed at the inner circumferential wall of the water pipe connector 21. The second engagement member 14 may be arranged corresponding to the first engagement member 13 and cooperate with the first engagement member 13 to restrict a movement of the heat insulation pipe 11 relative to the water pipe connector 21. In another exemplary embodiment of the present disclosure, the first engagement member 13 and the second engagement member 14 may be detachably connected through snapping or insertion. By providing the first engagement member 13 and the second engagement member 14, the engagement strength between the heat insulation pipe 11 and the water pipe connector 21 can be improved.

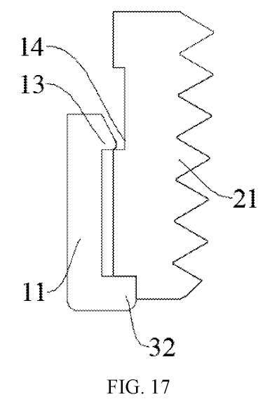

As shown in FIG. 17, further, the first engagement member 13 may be constructed as one of an engagement claw 113 and an engagement groove, and the second engagement member 14 may be constructed as another one of the engagement claw 113 and the engagement groove. An outer wall of the engagement claw 113 abuts against an inner wall of the engagement groove to realize an engagement between the engagement claw 113 and the engagement groove through snapping. In a specific embodiment, the first engagement member 13 may be constructed as the engagement claw 113, and the second engagement member 14 may be constructed as the engagement groove. Through the engagement between the engagement claw 113 and the engagement groove through snapping, the engagement claw 113 is received in the engagement groove, and an outer surface of the engagement claw 113 abuts against an inner surface of the engagement groove to restrict a movement of the engagement claw 113. In this way, limiting between the heat insulation pipe 11 and the water pipe connector 21 is realized.

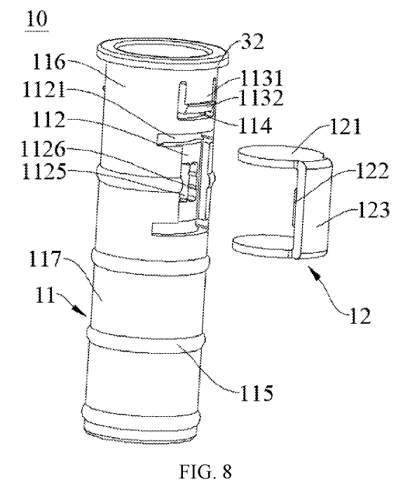

As shown in FIG. 8 to FIG. 12, in other embodiments of the present disclosure, the heat insulation pipe 11 may be provided with an engagement claw 113 formed at the outer circumferential wall of the heat insulation pipe 11, and the engagement claw 113 may be engaged with the inner circumferential wall of the water pipe connector 21, to further restrict the movement of the heat insulation pipe 11 relative to the water pipe connector 21. It can be understood that the outer surface of the engagement claw 113 may abut against the inner circumferential wall of the water pipe connector 21 to increase a friction force between the engagement claw 113 and the inner circumferential wall of the water pipe connector 21, i.e., a friction force between the heat insulation pipe 11 and the water pipe connector 21, to restrict the movement of the heat insulation pipe 11 relative to the water pipe connector 21.

As shown in FIG. 10 to FIG. 12, in some embodiments of the present disclosure, a deformation hole 114 may be formed at the heat insulation pipe 11. The engagement claw 113 may be arranged at an inner wall of the deformation hole 114, and may extend into the deformation hole 114 at an end of the engagement claw 113. The engagement claw 113 is movable within the deformation hole 114. It can be understood that the engagement claw 113 is movable towards or away from the first channel 111 relative to the deformation hole 11. For example, when the heat insulation pipe 11 is mounted in the water pipe connector 21, the engagement claw 113 is movable towards the inside of the first channel 111 by a predetermined distance, and then is movable away from the first channel 111 after the engagement claw 113 corresponds to the engagement groove to cause the engagement claw 113 to cooperate with the engagement groove. Therefore, by adopting the above structure, the mounting of the heat insulation pipe 11 can be facilitated, i.e., the occurrence of the interference between the engagement claw 113 and the water pipe connector 21 during the mounting of the heat insulation pipe 11 can be avoided.

As shown in FIG. 10 to FIG. 12 and 16, in some embodiments of the present disclosure, the engagement claw 113 may include a connection arm 1131 and an engagement head 1132. The connection arm 1131 may be connected to the inner wall of the deformation hole 114 and extend towards the inside of the deformation hole 114. The engagement head 1132 may be arranged at a free end of the connection arm 1131, and may protruding towards the inner circumferential wall of the water pipe connector 21. An outer diameter of an outer edge of the engagement head 1132 is D2, where 1.2 mm≤D2≤1.5 mm. It can be understood that the outer diameter of the outer edge of the engagement head 1132 may be any value ranging from 1.2 mm to 1.5 mm. For example, the outer diameter of the outer edge of the engagement head 1132 may be, but is not limited to, 1.2 mm, 1.3 mm, 1.4 mm, 1.5 mm, or the like. Such an arrangement can ensure that the engagement head 1132 after being assembled may directly abut against the inner wall of the water pipe connector 21 and generate a large force, making the heat insulation pipe 11 uneasily separated after being mounted.

In some embodiments of the present disclosure, the heat insulation pipe 11 may be constructed as a cylinder. Such an arrangement may facilitate mounting of the heat insulation pipe 11 in the water pipe connector 21. In addition, an occupied space of the heat insulation pipe 11 can be reduced. The heat insulation pipe 11 may be made of a polymer material with relatively low hardness, such as polyethylene (PE), polypropylene (PP), or cross-linked polyethylene (PEX). By adopting the above materials, it can be ensured that the engagement claw 113 is easy to deform during the mounting of the heat insulation pipe 11, and the mounting process will not be damaged due to the brittleness of the material.

The water heater 30 according to the embodiments of the present disclosure is briefly described below.

The water heater 30 according to the embodiments of the present disclosure is provided with the coupling device 20 according to the above embodiments. Since the water heater 30 according to the embodiments of the present disclosure is provided with the coupling device 20 according to the above embodiments, the coupling device 20 for the water heater 30 includes the water pipe connector 21, the heat insulation pipe 11, and the heat insulation member 12 arranged at the heat insulation pipe 11. The heat insulation pipe 11 may be arranged inside the water pipe connector 21 and be insulated from an inner wall of the water pipe connector 21 to form a balance cavity 212. The heat insulation pipe 11 may have the first channel 111 and a flow channel 119, and the balance cavity 212 may be in communication with the first channel 111 through the flow channel 119. Therefore, after water is introduced into the coupling device 20, water pressure in the balance cavity 212 and water pressure in the first channel 111 may be kept balanced, to avoid deformation of the heat insulation member 12 or decoupling of the heat insulation member 12 from the heat insulation pipe 11 and improve reliability of the water heater 30.

The coupling device 20 for the water heater 30 according to the embodiments of the present disclosure is described below with reference to FIG. 1 to FIG. 18. The coupling device 20 includes a water pipe connector 21 and the heat insulation pipe 11. The water pipe connector 21 has the mounting channel 211 formed in the water pipe connector 21, and the mounting channel 211 extends in the axial direction of the water pipe connector 21. The water pipe connector 21 is adapted to be in communication with a water tank cavity 313 at an end of the water pipe connector 21. The heat insulation pipe 11 is arranged within the mounting channel 211, and a gap is formed between at least part of the heat insulation pipe 11 and an inner circumferential wall of the water pipe connector 21. The inner circumferential wall of the water pipe connector 21 is provided with a protrusion 115 extending towards an outer circumferential wall of the heat insulation pipe 11; and/or the outer circumferential wall of the heat insulation pipe 11 is provided with a protrusion 115 extending towards the inner circumferential wall of the water pipe connector 21. The protrusion 115 is adapted to abut against the inner circumferential wall of the water pipe connector 21 or the outer circumferential wall of the heat insulation pipe 11 to form a seal between the water pipe connector 21 and the heat insulation pipe 11.

As shown in FIG. 14 and FIG. 15, in an exemplary embodiment of the present disclosure, the coupling device 20 may include the water pipe connector 21 and the heat insulation pipe 11. The mounting channel 211 may be formed in the water pipe connector 21 and may extend in the axial direction of the water pipe connector 21. The water pipe connector 21 may be in communication with the water tank cavity 313 at an end of the water pipe connector 21. The heat insulation pipe 11 may be arranged within the mounting channel 211, and the gap may be formed between the at least part of the heat insulation pipe 11 and the inner circumferential wall of the water pipe connector 21. The heat insulation pipe 11 is capable of reducing heat exchange of heat inside a water tank 31 with an external environment through the water pipe connector 21 when the water heater 30 is in static heat preservation.

Further, as shown in FIG. 15 to FIG. 18, the inner circumferential wall of the water pipe connector 21 may be provided with the protrusion 115 extending towards the outer circumferential wall of the heat insulation pipe 11; and/or the outer circumferential wall of the heat insulation pipe 11 is provided with the protrusion 115 extending towards the inner circumferential wall of the water pipe connector 21. In another exemplary embodiment of the present disclosure, the outer circumferential wall of the heat insulation pipe 11 may be provided with the protrusion 115 extending towards the inner circumferential wall of the water pipe connector 21. The protrusion 115 is capable of abutting against the inner circumferential wall of the water pipe connector 21 and realizing the sealing between the water pipe connector 21 and the heat insulation pipe 11. The protrusion 115 may realize fixation between the heat insulation pipe 11 and the water pipe connector 21 through its interference fit with the heat insulation pipe 11. In an exemplary embodiment of the present disclosure, the protrusion 115 abuts against the inner circumferential wall of the water pipe connector 21. In this way, a friction force between the protrusion 115 and the water pipe connector 21 is increased, to prevent the decoupling of the heat insulation pipe 11 from the water pipe connector 21. Alternatively, the inner circumferential wall of the water pipe connector 21 may be provided with the protrusion 115 extending towards the outer circumferential wall of the heat insulation pipe 11. The protrusion 115 is capable of abutting against the outer circumferential wall of the heat insulation pipe 11, to realize the relative the fixation between the heat insulation pipe 11 and the water pipe connector 21. Alternatively, each of the inner circumferential wall of the water pipe connector 21 and the outer circumferential wall of the heat insulation pipe 11 is provided with the protrusion 115. The protrusion 115 on the inner circumferential wall of the water pipe connector 21 extends towards the outer circumferential wall of the heat insulation pipe 11, and the protrusion 115 on the outer circumferential wall of the heat insulation pipe 11 extends towards the inner circumferential wall of the water pipe connector 21. The protrusion 115 on the inner circumferential wall of the water pipe connector 21 is capable of abutting against the outer circumferential wall of the heat insulation pipe 11, and the protrusion 115 on the outer circumferential wall of the heat insulation pipe 11 is capable of abutting against the inner circumferential wall of the water pipe connector 21, realizing the relative fixation between the heat insulation pipe 11 and the water pipe connector 21.

In short, the coupling device 20 according to the embodiments of the present disclosure is provided with the water pipe connector 21 and the heat insulation pipe 11 mounted inside the water pipe connector 21. The inner circumferential wall of the water pipe connector 21 may be provided with the protrusion 115 that may extend towards the outer circumferential wall of the heat insulation pipe 11; and/or the outer circumferential wall of the heat insulation pipe 11 may be provided with the protrusion 115 that may extend towards the inner circumferential wall of the water pipe connector 21. Moreover, the protrusion 115 may abut against the inner circumferential wall of the water pipe connector 21 or the outer circumferential wall of the heat insulation pipe 11. In this way, an interference fit is achieved, to further prevent the decoupling of the heat insulation pipe 11 from the water pipe connector 21. In this way, the engagement strength between the heat insulation pipe 11 and the water pipe connector 21 is improved, and reliability of the coupling device 20 is ensured.

As shown in FIG. 15 and FIG. 16, in some embodiments of the present disclosure, a plurality of protrusions 115 may be constructed, and may be arranged at intervals in the axial direction of the heat insulation pipe 11. By providing the plurality of protrusions 115, a contact area and a friction force between the heat insulation pipe 11 and the water pipe connector 21 can be further increased, and the engagement strength between the heat insulation pipe 11 and the water pipe connector 21 can be further improved. Outer diameters of the plurality of protrusions 115 increases gradually towards the water tank cavity 313. It can be understood that the heat insulation pipe 11 is mounted inwardly from an end of the water pipe connector 21 towards the water tank cavity 313. By setting the outer diameters of the plurality of protrusions 115 as per the above structure, the mounting of the heat insulation pipe 11 into the water pipe connector 21 can be facilitated.

As shown in FIG. 1 and FIG. 7, in some embodiments of the present disclosure, at least one of the plurality of protrusions 115 may be constructed into a ring or arc shape extending in a circumferential direction of the heat insulation pipe 11. By constructing the protrusion 115 into the ring or arc shape, the contact area and the friction force between the heat insulation pipe 11 and the water pipe connector 21 can be further increased, and the engagement strength between the heat insulation pipe 11 and the water pipe connector 21 can be further improved.

In some embodiments of the present disclosure, the plurality of protrusions 115 may be provided at the heat insulation pipe 11. A minimum outer diameter of the plurality of protrusions 115 is d1, and an inner diameter of the water pipe connector 21 is d2, where d1>d2. It can be understood that the minimum outer diameter of the plurality of protrusions 115 is greater than the inner diameter of the water pipe connector 21. Such an arrangement can ensure that after the heat insulation pipe 11 is mounted in the water pipe connector 21, the protrusion 115 may have an interference fit with the inner wall of the water pipe connector 21. The protrusion 115 deforms towards the heat insulation pipe 11 to generate a radially outward acting force, which increases the friction force between the heat insulation pipe 11 and the water pipe connector 21, to prevent the decoupling of the heat insulation pipe 11 from the water pipe connector 21.

In some embodiments of the present disclosure, a maximum outer diameter of the plurality of protrusions 115 is d3, where 1.2 mm≤d3≤1.5 mm. It can be understood that the maximum outer diameter of the plurality of protrusions 115 is any value ranging from 1.2 mm to 1.5 mm. For example, the maximum outer diameter of the plurality of protrusions 115 may be, but is not limited to, 1.2 mm, 1.3 mm, 1.4 mm, 1.5 mm, or the like. In response to the maximum outer diameter of the protrusions 115 being too large, the mounting of the heat insulation pipe 11 is caused to be difficult, resulting in a problem where the heat insulation pipe 11 is easily damaged during the mounting. In response to the maximum outer diameter of the protrusions 115 being too small, the engagement strength between the heat insulation pipe 11 and the water pipe connector 21 is caused to be insufficient, resulting in a problem where the heat insulation pipe 11 is easily separated from the interior of the water pipe connector 21. Therefore, by setting the maximum outer diameter of the plurality of protrusions 115 within the above range, an interference fit margin is caused to still occur between the protrusion 115 of the heat insulation pipe 11 and the water pipe connector 21, and thus it is ensured that the heat insulation pipe 11 is not separated after being mounted.

As shown in FIG. 15 and FIG. 16, in some embodiments of the present disclosure, a cross section of the plurality of protrusions 115 in an extending direction of the plurality of protrusions 115 is triangular or circular-arc-shaped. Such an arrangement can ensure that after the heat insulation pipe 11 and the water pipe connector 21 are mounted, a contact area between the protrusion 115 and the inner wall of the water pipe connector 21 is small, facilitating the mounting of the heat insulation pipe 11.

As shown in FIG. 7 to FIG. 13, in other embodiments of the present disclosure, the heat insulation pipe 11 has a first engagement member 113 formed at the outer circumferential wall of the heat insulation pipe 11. The engagement claw 113 is capable of being engaged with the inner circumferential wall of the water pipe connector 21, limiting the movement of the heat insulation pipe 11 relative to the water pipe connector 21. It can be understood that the outer surface of the engagement claw 113 is capable of abutting against the inner circumferential wall of the water pipe connector 21 to increase the friction force between the engagement claw 113 and the inner circumferential wall of the water pipe connector 21, i.e., the friction force between the heat insulation pipe 11 and the water pipe connector 21, to restrict the movement of the heat insulation pipe 11 relative to the water pipe connector 21.

As shown in FIG. 8, in some embodiments of the present disclosure, the heat insulation pipe 11 may include a first segment 116 and a second segment 117. The first segment 116 may be in communication with the water tank cavity 313 at an end of the first segment 116, and have the engagement claw 113 formed at the first segment 116. The second segment 117 may be connected to the first segment 116 and have the plurality of protrusions 115 provided at the second segment 117. The heat insulation member 12 may be arranged at a connection between the first segment 116 and the second segment 117. It can be understood that the protrusion 115 and the engagement claw 113 may be arranged at two sides of the heat insulation member 12 in the axial direction of the heat insulation member 12, respectively. Moreover, the protrusion 115 and the engagement claw 113 may realize the limiting between the heat insulation pipe 11 and the water pipe connector 21, respectively. In this way, the engagement strength between the heat insulation pipe 11 and the water pipe connector 21 is improved.

The water heater 30 according to the embodiments of the present disclosure is briefly described below.

The water heater 30 according to the embodiments of the present disclosure is provided with the coupling device 20 according to the above embodiments. Since the water heater 30 according to the embodiments of the present disclosure is provided with the coupling device 20 according to the above embodiments, the coupling device 20 for the water heater 30 is provided with the water pipe connector 21 and the heat insulation pipe 11 mounted inside the water pipe connector 21. An inner circumferential wall of the water pipe connector 21 may be provided with a protrusion 115 that may extend towards an outer circumferential wall of the heat insulation pipe 11; and/or the outer circumferential wall of the heat insulation pipe 11 may be provided with a protrusion 115 that may extend towards the inner circumferential wall of the water pipe connector 21. Moreover, the protrusion 115 may abut against the inner circumferential wall of the water pipe connector 21 or the outer circumferential wall of the heat insulation pipe 11. In this way, an interference fit is achieved, to prevent the decoupling of the heat insulation pipe 11 from the interior of the water pipe connector 21. In this way, an engagement strength between the heat insulation pipe 11 and the water pipe connector 21 is improved, and reliability of the coupling device 20 is further improved.

The water heater 30 according to the embodiments of the present disclosure is described below with reference to FIG. 1 to FIG. 20. The water heater 30 includes a water tank 31, the water pipe connector 21, and a water inlet pipe 34. A water tank connector 311 is provided at the water tank 31. A water inlet channel 3111 is formed in the water tank connector 311. The water pipe connector 21 is partially received in the water inlet channel 3111 and coupled with the water tank connector 311. The water inlet pipe 34 is partially arranged in the water inlet channel 3111. A first insulation member 32 is provided between the water inlet pipe 34 and the water pipe connector 21 to insulate the water inlet pipe 34 from the water pipe connector 21, and a second insulation member 33 is provided between the water inlet pipe 34 and the water tank connector 311 to insulate the water inlet pipe 34 from the water tank connector 311.

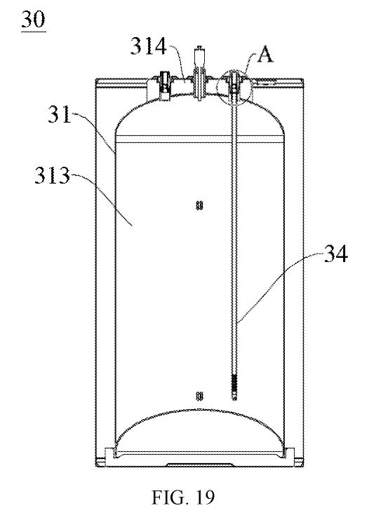

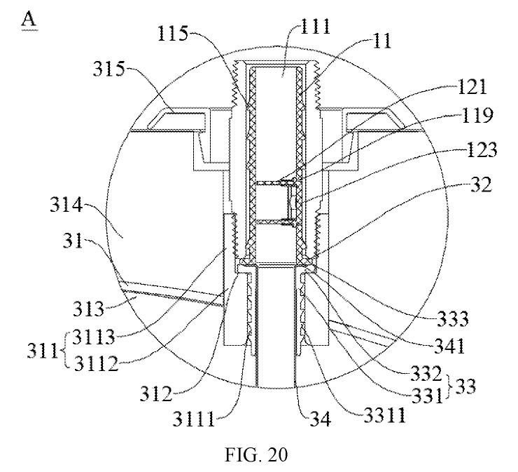

As shown in FIG. 19 and FIG. 20, in an exemplary embodiment of the present disclosure, the water heater 30 may include the water tank 31, the water pipe connector 21, and the water inlet pipe 34. The water tank 31 may be provided with the water tank connector 311. In another exemplary embodiment of the present disclosure, the water tank connector 311 may be fixedly connected to the water tank 31 by welding to avoid water leakage. The water inlet channel 3111 may be formed inside the water tank connector 311, and may be in communication with an inner cavity of the water tank 31. The water pipe connector 21 may be partially received in the water inlet channel 3111, and may be coupled with the water tank connector 311. In another exemplary embodiment of the present disclosure, the water pipe connector 21 and the water tank connector 311 may be in threaded engagement. The water inlet pipe 34 may be partially arranged in the water inlet channel 3111. The first insulation member 32 may be provided between the water inlet pipe 34 and the water pipe connector 21, and the second insulation member 33 may be provided between the water inlet pipe 34 and the water tank connector 311. The first insulation member 32 is capable of spacing the water inlet pipe 34 from the water pipe connector 21, and the second insulation member 33 is capable of spacing the water inlet pipe 34 from the water tank connector 311.

It should be noted that a magnesium rod may be provided at the water tank 31, and the water tank 31 is provided with a water tank connector 311. The water tank connector 311 and the magnesium rod may be indirectly connected, and the water pipe connector 21 may be connected to the water tank connector 311. Therefore, the water pipe connector 21 and the magnesium rod may also be indirectly connected. The first insulation member 32 is capable of spacing the water inlet pipe 34 from the water pipe connector 21, and the second insulation member 33 is capable of spacing the water inlet pipe 34 from the water tank connector 311. It can be understood that the first insulation member 32 and the second insulation member 33 are capable of spacing and insulating the water inlet pipe 34 from the water pipe connector 21 and the water tank connector 311, i.e., the water inlet pipe 34 is not in communication with the magnesium rod through the water pipe connector 21 and the water tank connector 311. Even if a bottom end of the water inlet pipe 34 is in communication with the magnesium rod through water inside the water tank 31, a complete electrochemical path cannot be constructed, making the magnesium rod not protect the water inlet pipe 34, avoiding excessive consumption of the magnesium rod, and improving a service life of the magnesium rod.

In short, the water heater 30 according to the embodiments of the present disclosure is provided with the water tank 31, the water pipe connector 21, and the water inlet pipe 34. The water tank 31 is provided with the water tank connector 311. The water inlet pipe 34 may be arranged in the water tank connector 311. Moreover, the first insulation member 32 is arranged between the water inlet pipe 34 and the water pipe connector 21, and the second insulation member 33 is arranged between the water inlet pipe 34 and the water tank connector 311. Each of the first insulation member 32 and the second insulation member 33 is capable of spacing the water inlet pipe 34 from the water pipe connector 21 and the water tank connector 311. In this way, the complete electrochemical path cannot be formed between the magnesium rod and the water inlet pipe 34, the excessive consumption of the magnesium rod is avoided, and the service life of the magnesium rod is improved.

As shown in FIG. 20, in some embodiments of the present disclosure, the water inlet pipe 34, at an end closer to the water inlet connector 21 than the other, is provided with a first flange 341. The first flange 341 may extend and protrude in a radial direction of the water inlet pipe 34. The first flange 341 may abut against the first insulation member 32 and the second insulation member 33, respectively. In this way, it is realized that the first flange 341 is restricted by the first insulation member 32 and the second insulation member 33. In some embodiments, the first flange 341 may be constructed into a ring flange, and may realize effects of limiting and mounting the water inlet pipe 34.

As shown in FIG. 20, in some embodiments of the present disclosure, the water heater 30 may include the heat insulation pipe 11. The heat insulation pipe 11 may be arranged inside the water pipe connector 21, and may have a first insulation member 32 arranged at an end, closer to the water inlet pipe 11 than the other, of the heat insulation pipe 11. The first insulation member 32 may extend radially, and a side of the first insulation member 32 may abut against the first flange 341. In some embodiments, a flange may be formed at the end of the heat insulation pipe 11 close to the water pipe connector 21, and may be constructed as the first insulation member 32, i.e., the first insulation member 32 and the heat insulation pipe 11 are constructed to be integrally formed to facilitate processing and mounting. The first insulation member 32 is capable of spacing the first flange 341 from the water pipe connector 21 and achieving an insulation effect.

As shown in FIG. 20, in some embodiments of the present disclosure, the second insulation member 33 may include a first insulation part 331 and a second insulation part 332. The first insulation part 331 may be arranged inside the water inlet channel 3111 and located between the water inlet pipe 34 and an inner wall of the water tank connector 311. The first insulation part 331 is capable of spacing the water inlet pipe 34 from the inner wall of the water tank connector 311 and realizing insulation between the water inlet pipe 34 and the water tank connector 311. The second insulation part 332 may be arranged at an end, closer to the heat insulation pipe 11 than the other, of the first insulation part 331 and may extend radially. The radial direction may be the radial direction of the heat insulation pipe 11. The second insulation part 332 is capable of abutting against the first flange 341. It can be understood that the second insulation part 332 is capable of spacing the first flange 341 from the inner wall of the water tank connector 311 and achieving an insulation effect. In some embodiments, the first insulation member 32 and the second insulation part 332 may be located on two sides of the first flange 341 in an axial direction of the water inlet pipe 34, to facilitate axial limiting of the first flange 341 by the first insulation member 32 and the second insulation part 332. In some embodiments, the second insulation member 33 may be constructed as a silicone sleeve.

As shown in FIG. 20, in some embodiments of the present disclosure, the second insulation part 332 may extend beyond an outer edge of the first flange 341 and is capable of abutting against the first insulation member 32 and radially limiting the first flange 341, while spacing an outer periphery of the first flange 341 from the inner circumferential wall of the water tank connector 311 and achieving an insulation effect. Further, an extension 333 may be formed at an outer periphery of the second insulation part 332. The extension 333 may extend towards the first insulation member 32, and a free end of the extension 333 may abut against the first insulation member 32 to completely wrap the outer periphery of the first flange 341, ensuring the insulation effect of the second insulation member 33.

As shown in FIG. 20, in some embodiments of the present disclosure, a third limit member 3311 may be formed at an outer circumferential wall of the first insulation part 331 and is capable of abutting against the inner wall of the water tank 31. It should be noted that the third limit member 3311 may have an interference fit with the water tank 31. When the first insulation part 331 is mounted inside the water tank 31, the third limit member 3311 may deform inwardly. In this way, an acting force is exerted on the inner wall of the water tank 31, a friction force between the first insulation part 331 and the water tank 31 is increased, to prevent the decoupling of the first insulation part 331 from the water tank 31. Further, a plurality of third limit members 3311 may be constructed and may be arranged at intervals in the axial direction of the water inlet pipe 34. By providing the plurality of third limit members 3311, an engagement strength between the first insulation part 331 and the water tank 31 can be further improved, to prevent the decoupling of the first insulation part 331 from the water tank 31.

As shown in FIG. 20, in some embodiments of the present disclosure, a step surface 312 may be formed at the inner wall of the water tank connector 311, and the second insulation part 332 may abut between the step surface 312 and the first flange 341. The step surface 312 may provide an axial acting force to the second insulation part 332, realizing axial limiting of the second insulation part 332 and the first flange 341. In some embodiments, the step surface 312 may be constructed into a ring surface and may provide a predetermined space for mounting the second insulation part 332.

Further, the water tank connector 311 may include a first connector segment 3112 and a second connector segment 3113. The first connector segment 3112 may be arranged at the water tank 31, and the interior of the first connector segment 3112 may abut against the first insulation part 331. In an exemplary embodiment of the present disclosure, an inner wall of the first connector segment 3112 may axially abut against the first insulation part 331, and the second connector segment 3113 may be connected to an end of the first connector segment 3112 close to the heat insulation pipe 11 and may be connected to the water pipe connector 21. Moreover, a step surface 312 is formed at a connection between the second connector segment 3113 and the first connector segment 3112. An inner diameter of the second connector segment 3113 may be greater than an inner diameter of the first connector segment 3112 to facilitate the mounting of the heat insulation pipe 11.

As shown in FIG. 19 and FIG. 20, in some embodiments of the present disclosure, the water heater 30 may further include a heat preservation member 314. A water tank cavity 313 may be further formed inside the water tank 31 and may be configured to receive a part of the water inlet pipe 34. A magnesium rod may be further provided at the water tank 31. The magnesium rod is capable of extending into the water tank cavity 313 and being in contact with the water in the water tank cavity 313. The heat preservation member 314 may be arranged at an outer circumferential wall of the water tank 31 to achieve a heat insulation and preservation effect. A decoration member 315 may be provided at an outer wall of the heat preservation member 314, and the decoration member 315 may be arranged corresponding to the water pipe connector 21.

In the description of the present disclosure, it should be understood that, orientation or position relationship indicated by terms such as “center,” “longitudinal,” “lateral,” “length,” “width,” “thickness,” “over,” “below,” “front,” “back,” “left,” “right,” “vertical,” “horizontal,” “top,” “bottom,” “in,” “out,” “clockwise,” “anti-clockwise,” “axial,” “radial,” and “circumferential” is based on the orientation or position relationship shown in the accompanying drawings, and is merely for the convenience of describing the present disclosure and simplifying the description, rather than indicating or implying that the associated device or element must have a specific orientation, or be constructed and operated in a specific orientation, and therefore cannot be understood as a limitation on the present disclosure.

In the description of the present disclosure, the features associated with “first” and “second” may explicitly or implicitly include at least one of the features.

In the description of the present disclosure, the term “plurality” means two or more.

In the description of the present disclosure, the first feature being “on” or “under” the second feature may include the first feature being in direct contact with the second feature, or the first feature being not in direct contact with the second feature, but being in contact with the second feature through another feature therebetween.

In the description of the present disclosure, the first feature being “above” the second feature includes the first feature being directly above or obliquely above the second feature, or simply mean that a level of the first feature is higher than a level of the second feature.

In the description of this specification, descriptions with reference to the terms “an embodiment,” “some embodiments,” “schematic embodiments,” “examples,” “specific examples,” or “some examples,” etc. mean that specific features, structure, materials, or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner.

Although the embodiments of the present disclosure have been shown and described above, it can be understood by those skilled in the art that various changes, modifications, replacements, and variations can be made to these embodiments without departing from the principles and ideas of the present disclosure. The scope of the invention is defined by the claims as attached and their equivalents.

What is claimed is:

1. A water heater comprising:
a water tank provided with a water tank connector, a water inlet channel being formed in the water tank connector;
a water inlet connector partially received in the water inlet channel and coupled with the water tank connector;
a water inlet pipe partially arranged in the water inlet channel;
a first insulation member arranged between the water inlet pipe and the water inlet connector to insulate the water inlet pipe from the water inlet connector; and
a second insulation member arranged between the water inlet pipe and the water tank connector to insulate the water inlet pipe from the water tank connector.

2. The water heater according to claim 1, wherein a flange is provided at one end of the water inlet pipe that is closer to the water inlet connector than another end of the water inlet pipe, the flange extending and protruding in a radial direction, and abutting the first insulation member and the second insulation member.

3. The water heater according to claim 2, further comprising:
a heat insulation pipe arranged in the water inlet connector;
wherein:
the first insulation member is arranged at one end of the heat insulation pipe that is closer to the water inlet pipe than another end of the heat insulation pipe;
the flange is a first flange; and
the first insulation member includes a second flange extending along the radial direction.

4. The water heater according to claim 3, wherein the second insulation member includes:
a first insulation part arranged in the water inlet channel and located between the water inlet pipe and an inner wall of the water tank connector; and
a second insulation part arranged at one end of the first insulation part that is closer to the heat insulation pipe than another end of the first insulation part, the second insulation part extending along the radial direction and abutting the first flange.

5. The water heater according to claim 4, wherein the first insulation member and the second insulation part are located at two sides of the first flange in an axial direction of the water inlet pipe.

6. The water heater according to claim 4, wherein the second insulation part extends beyond an outer edge of the first flange and abuts the first insulation member.

7. The water heater according to claim 6, wherein an extension is formed at an outer circumferential edge of the second insulation part, the extension extending towards and abutting the first insulation member.

8. The water heater according to claim 4, wherein a limit protrusion is formed at an outer circumferential wall of the first insulation part, the limit protrusion abutting an inner wall of the water tank.

9. The water heater according to claim 8, wherein the limit protrusion is one of a plurality of limit protrusions arranged at intervals in an axial direction of the water inlet pipe.

10. The water heater according to claim 4, wherein a step surface is formed at the inner wall of the water tank connector, and the second insulation part is located between and abuts the step surface and the first flange.

11. The water heater according to claim 10, wherein the water tank connector includes:
a first connector segment arranged at the water tank, an inner wall of the first connector segment abutting the first insulation part; and
a second connector segment connected to one end of the first connector segment that is closer to the heat insulation pipe than another end of the first connector segment, the second connector segment being connected to the water inlet connector, and the step surface being formed at a connection between the second connector segment and the first connector segment.

12. The water heater according to claim 1, further comprising:
a heat insulation member arranged on an outer circumferential wall of the water tank.
